(19) United States
(12) Patent Application Publication
(10) Pub. No.: US 2020/0110403 A1
(43) Pub. Date: Apr. 9, 2020

(54) AGRICULTURAL DATA CENTER SYSTEMS, NETWORKS, AND METHODS

(71) Applicant: CNH Industrial America LLC, New Holland, PA (US)

(72) Inventor: Ivan Antich, Willowbrook, IL (US)

(73) Assignee: CNH Industrial America LLC

(21) Appl. No.: 16/154,247

(22) Filed: Oct. 8, 2018

(51) Int. Cl. G05D 1/00; H04W 4/44; G05D 1/02

(52) U.S. Cl. CPC G05D 1/0022; H04W 4/44; G05D 2201/0201; G05D 1/0285; G05D 1/0027

(57) ABSTRACT

In one aspect, to a method of data replication and sharing in an agricultural area with a communications system is provided. The communications system can include a base station, a plurality of remote nodes in operative communication with the base station, and at least one agricultural machine within range of the base station or at least one of the remote nodes. The method can include collecting, at the at least one agricultural machine, data from the agricultural area, transmitting, from the at least one agricultural machine, the collected data to a first remote node of the plurality of remote nodes, replicating the collected data at each operational remote node of the plurality of remote nodes neighboring the first remote node, and receiving, at the at least one agricultural machine, status information originating from one or more remote nodes of the plurality of remote nodes from the first remote node.

### FIELD OF THE INVENTION

The present subject matter relates generally to sharing data within and/or across various agricultural areas, and more specifically, to systems, networks, and methods of transmitting and receiving agricultural data within and/or across agricultural areas.

### BACKGROUND OF THE INVENTION

Often, agricultural areas are remote from typical urban infrastructure including telephone utilities, fiber optic network nodes, cell transmission towers, and other telecommunication infrastructure. Additionally, agricultural areas, such as farms and fields, may include a vast geographical area covering hundreds of hectares of land area or more. When considering the vast land area, lack of infrastructure, and types of vehicles used to work this land, it becomes apparent that real-time communications of data related to an area encompassing a particular agricultural area may be difficult.

Accordingly, communications systems for agricultural areas that allow for more efficient transmission of data related to the agricultural area would be welcomed in the technology.

### BRIEF DESCRIPTION OF THE INVENTION

Aspects and advantages of the invention will be set forth in part in the following description, or may be obvious from the description, or may be learned through practice of the invention.

In one embodiment, the present subject matter is directed to a system of real-time data replication and sharing in an agricultural area. The system can include a base station. The base station can include at least one transceiver being operative to receive and transmit data collected from the agricultural area. The system can also include a plurality of remote nodes in operative communication with the base station. Each of the plurality of remote nodes can be positioned within a predetermined range from the base station or a predetermined range from each other in at least a partial mesh configuration. Also, each remote node can include at least one transceiver being operative to receive and transmit data from the base station and receive, replicate, and transmit data collected from neighboring remote nodes of the plurality of remote nodes and the agricultural area. The system can also include at least one agricultural machine within range of the base station or at least one of the remote nodes. The at least one agricultural machine can include a computer apparatus configured to receive data from the agricultural area, to transmit the received data to a first remote node of the plurality of remote nodes, and to receive replicated data originating from one or more remote nodes of the plurality of remote nodes from the first remote node.

In another embodiment, the present subject matter is directed to a method of data replication and sharing in an agricultural area with a communications system. The communications system can include a base station, a plurality of remote nodes in operative communication with the base station, and at least one agricultural machine within range of the base station or at least one of the remote nodes. The method can include collecting, at the at least one agricultural machine, data from the agricultural area, transmitting, from the at least one agricultural machine, the collected data to a first remote node of the plurality of remote nodes, replicating the collected data at each operational remote node of the plurality of remote nodes neighboring the first remote node, and receiving, at the at least one agricultural machine, status information originating from one or more remote nodes of the plurality of remote nodes from the first remote node.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic view of an agricultural communication network in accordance with aspects of the present subject matter;

FIG. 2 illustrates an example system of real-time data replication and sharing in an agricultural area using an agricultural communication network, such as the agricultural communication network of FIG. 1, in accordance with aspects of the present subject matter;

FIG. 3 illustrates an additional example system of real-time data replication and sharing in an agricultural area using an agricultural communication network, such as the agricultural communication network of FIG. 1, in accordance with aspects of the present subject matter;

FIG. 4 illustrates a flowchart of one embodiment of a method of data sharing in an agricultural communication network, such as the agricultural communication network of FIG. 1, in accordance with aspects of the present subject matter;

FIG. 5 illustrates a flowchart of one embodiment of a method of data sharing in an agricultural communication network, such as the agricultural communication network of FIG. 1, in accordance with aspects of the present subject matter;

FIG. 6 illustrates a flowchart of one embodiment of a method of communication in an agricultural communication network, such as the agricultural communication network of FIG. 1, in accordance with aspects of the present subject matter;

FIG. 7 illustrates a communication diagram of one embodiment of a method for vehicle-to-vehicle communications in an agricultural communication network, such as the agricultural network of FIG. 1, in accordance with aspects of the present subject matter;

FIG. 8 illustrates a flowchart of one embodiment of a method for vehicle-to-vehicle communications in an agricultural communication network, such as the agricultural communication network of FIG. 1, in accordance with aspects of the present subject matter; and

FIG. 9 illustrates a block diagram of an example computing system that can be used to implement various components, systems, and methods in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to an agricultural communication network and associated components, arranged as an agricultural communication system. In several embodiments, the agricultural communication system can include a base station being central, or logically centralized, in the system. The base station can include one or more transceivers being operative to receive and transmit data collected from the agricultural area and an uplink or uplink transceiver. The uplink transceiver can be operative to communicate with a remote network, such as the Internet. The uplink can also be used to communicate with various remote data stores or application execution environments. For example, the base station can access information stored in remote data stores and/or receive applications, instructions, or other data from application execution environments.

The agricultural communication system can also include a plurality of remote nodes in operative communication with the base station. Generally, each of the plurality of remote nodes can be positioned within a predetermined range from the base station or a predetermined range from each other in at least a partial mesh configuration. As used herein, an at least partial mesh configuration refers to a networking configuration where each remote node can communicate with all operational remote nodes within an operating distance of the node. In some examples, each node may fully communicate with all neighboring nodes. In some examples, each node may be limited to communicating with only a default neighboring node or default number of neighboring nodes, depending upon a desired configuration.

Generally, each remote node can also include a transceiver being operative to receive and transmit data from the base station. The transceiver can also be used to receive, replicate, and transmit data collected from neighboring remote nodes of the plurality of remote nodes and the agricultural area. For example, individual remote nodes can communicate with neighboring nodes, share information, replicate information, and pass along the shared information to other components of the communication system, such as agricultural machines or computing apparatuses, such as laptops, tablets, and the like.

In this regard, agricultural machines and other devices may access data shared by the remote nodes in a substantially real-time manner. As used herein, the term “real-time” and “substantially real-time” refer to data access available immediately after collection by the remote nodes. For example, the remote nodes may replicate data collected across all operational nodes. Upon collection, agricultural machines and computer apparatuses in communication with at least one remote node or the base station may access the replicated data such that real-time data access from within the communication system is feasible.

Various types of data may be replicated and shared using the agricultural communication system. For example, status information including an overall working condition of the covered agricultural area may be accessed with the agricultural communication system. The covered agricultural area may refer to an area of land worked by agricultural machines in communication with at least one remote node. Additionally, as used herein, the term “overall working condition” refers to data representing a status of the agricultural area collected from a predetermined or desired percentage of remote nodes. According to one example, the predetermined or desired percentage is data from 100% of operational remote nodes. According to another example, the predetermined or desired percentage is from more than 75% of operational remote nodes. Various modifications in the particular percentage may be made based on the type of agricultural area, the amount of area actually being used, and other considerations.

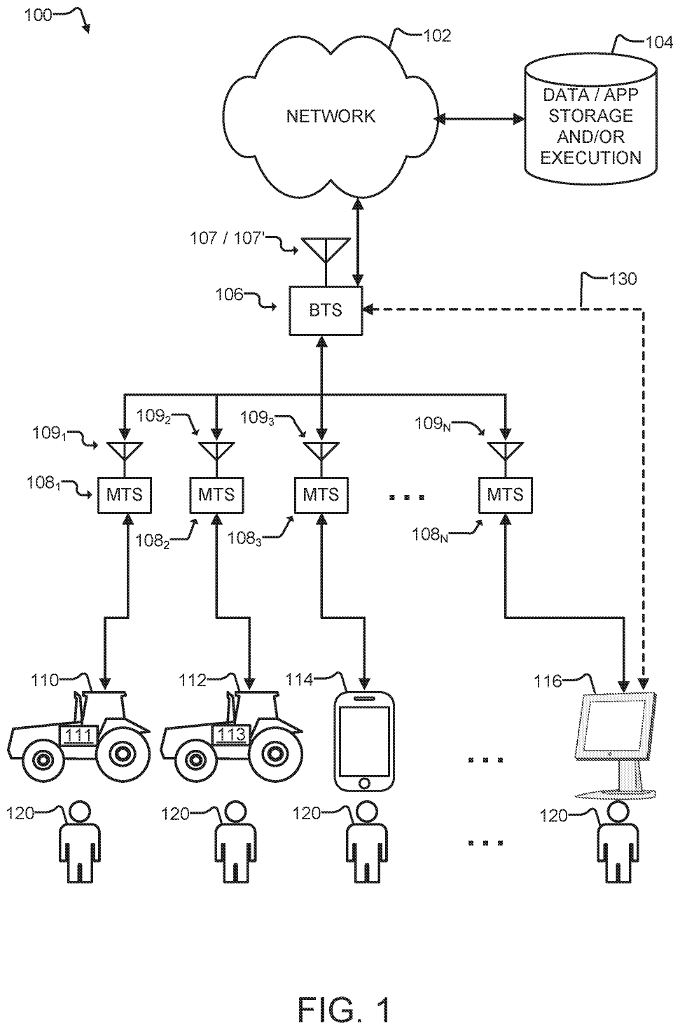

Referring now to the drawings, FIG. 1 illustrates a schematic of an agricultural communication network 100 in accordance with aspects of the present subject matter. The network 100 may include a base station 106. The base station 106 is a central, or logically centralized station, in the network 100. The base station 106 can include one or more transceivers 107 to receive and transmit data collected from an agricultural area and one or more uplinks or uplink transceivers 107′. The transceiver(s) 107, 107′ can include any necessary or suitable transceivers. For example, the transceiver(s) 107, 107′ can include one or more real-time kinematic transceivers, wireless transceivers, and/or radio transceivers. According to at least one embodiment, the transceiver(s) 107, 107′ includes at least one wireless networking transceiver configured to communicate over a wireless communication protocol. The wireless networking transceiver can include a fast wireless-connection based on suitable networking technology.

The uplink transceiver 107′ can be operative to communicate with a remote network 102, such as the Internet, and can include a satellite or cellular uplink. Wired uplinks may also be applicable in some scenarios. The base station 106 can also communicate with remote server 104 via the uplink. For example, the remote server 104 may include data storage, application storage, and/or an application execution environment, such as a software-as-a-service environment or other environment.

The base station 106 may also include other components, such as additional communication interfaces, computing devices or processors, memory or data storage, and other suitable components. Additionally, the network 100 may be expanded to include more than one base station in sonic implementations.

As further illustrated, the network 100 includes a plurality of remote mobile transceiver stations 108, or remote nodes 108, in operative communication with the base station 106, in an at least partial mesh configuration. Each remote node 108 may include at least one transceiver 109 configured to communicate over a wireless communication protocol. Furthermore, the remote nodes 108 may be configured to at least partially bridge communications between neighboring nodes and/or the base station 106. Therefore, each remote node 108 can communicate with a neighboring remote node 108 and/or the base station 106.

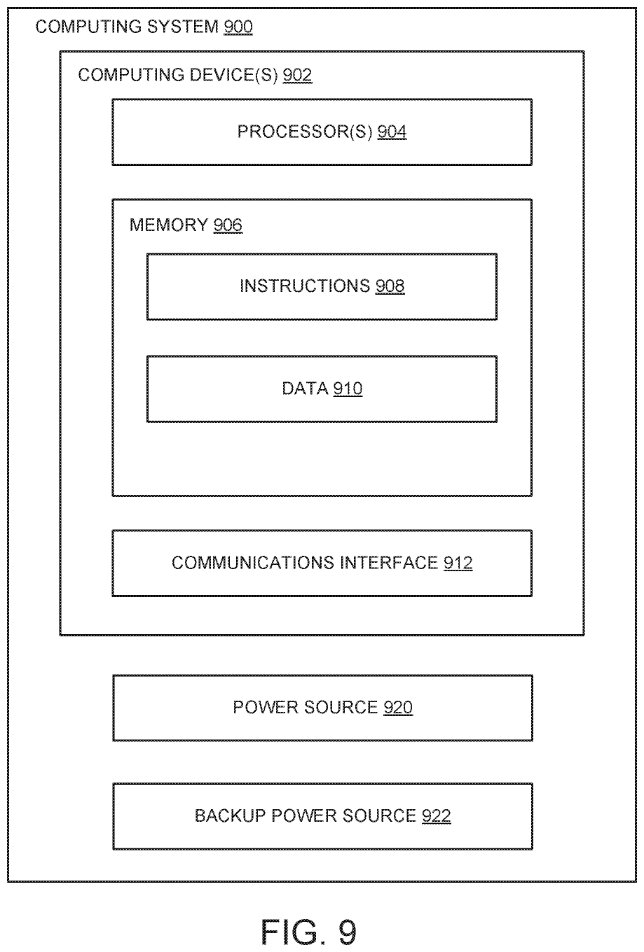

Generally, each remote node 108 may be a device arranged to operate in an external environment. As such, each remote node 108 may include a housing configured to house the transceiver(s) 109, antenna, one or more power sources (e.g., a primary power source, such as a solar-based power source, and a secondary power source, such as a backup battery power source, illustrated in FIG. 9), and any component or fixture necessary for placement in an agricultural area. Additionally, each remote node 108 can be configured to provide a power status to the base station 106, for example, including a status of one or more of the power sources. According to at least one embodiment, each remote node is configured to be a mobile device and placed in varying non-fixed locations. The locations may be adjusted throughout any period. It should be understood that the remote nodes may also be relatively easily replaceable with other remote nodes to ensure each remote node is operational. Furthermore, the remote nodes may be placed such that at least one networking connection is available from each remote node to the base station 106, with any number of remote nodes being placed therebetween to facilitate the connection.

As a non-limiting example, remote nodes 108₁ and 108₂ may be in operative communication with one another. Furthermore, remote nodes 108₂ and 108₃ may be in operative communication with one another. Finally, remote node 108₃ may be in operative communication with the base station 106. Accordingly, data can be accessed from the base station 106 through the remote node 108₁, through the at least partially bridged connection of remote node 108₁»108₂, remote node 108₂»108₃, and remote node 108₃» base station 106. In this manner, data can also be transmitted back to the base station 106 through the at least partially bridged connection described above. It is noted that other particular combinations of the shared or bridged connection are possible, including one or more remote nodes 108₁ through 108_{N}, and all such combinations and implementations are within the scope of this disclosure.

In addition to the at least partial mesh configuration described above, remote nodes 108 of the network 100 may be accessed individually by a variety of computing apparatuses or components. For example, one or more agricultural vehicles 110, 112 within range of a remote node 108 may communicate therewith. Each agricultural vehicle 110, 112 can include a computing apparatus 111, 113, respectively, having a transceiver capable of communicating with a transceiver of a remote node 108 over a wireless communication protocol. In this manner, if an agricultural vehicle 110, 112 is within range of a remote node 108, the agricultural vehicle 110, 112 can access data from every operational remote node 108 of the network 100 using an associated computer apparatus 111, 113. Furthermore, the accessed data may be presented at the agricultural vehicle 110, 112 in any suitable manner. According to at least one embodiment, the computer apparatus 111, 113 of the agricultural vehicle 110, 112 can provide a graphical user interface to an operator 120 of the agricultural machine. The graphical user interface can visualize or present the accessed data to the operator 120, including data related to one or more remote nodes 108 and/or status information related to the agricultural area.

The network 100 can also include a plurality of other computing devices, such as devices 114 and 116 (e.g., a mobile phone and/or a desktop computer), in communication with one or more remote nodes 106 over a wireless communication protocol. The devices 114 and 116 can include a transceiver capable of communicating with a transceiver of a remote node 108. In this manner, if a device 114 or 116 is within range of a remote node 108, the device can access data from every operational remote node 108 of the network 100.

It is noted that although particularly illustrated as agricultural vehicles, such as tractors, the agricultural vehicles 110, 112 may also be embodied as other vehicles, including aerial vehicles, autonomous vehicles, autonomous agricultural vehicles, non-powered vehicles (e.g., trailers or agricultural implements), or other suitable vehicles. Furthermore, the particular forms of devices 114 and 116 may also be varied.

Using the infrastructure of the network 100, associated operators 120 of the agricultural vehicles 110, 112, and/or devices 114 and 116, can access data shared or replicated across remote nodes 108 and the base station 106. Thus, while only a single networking connection may exist between a device and a particular remote node 108, the at least partial mesh configuration may allow data access as if directly connected with the base station 106, represented with the dashed line 130 of FIG. 1. Therefore, it should be understood that logically, substantially real-time data access to data accessible by the base station 106 is possible across areas served by remote nodes 108.

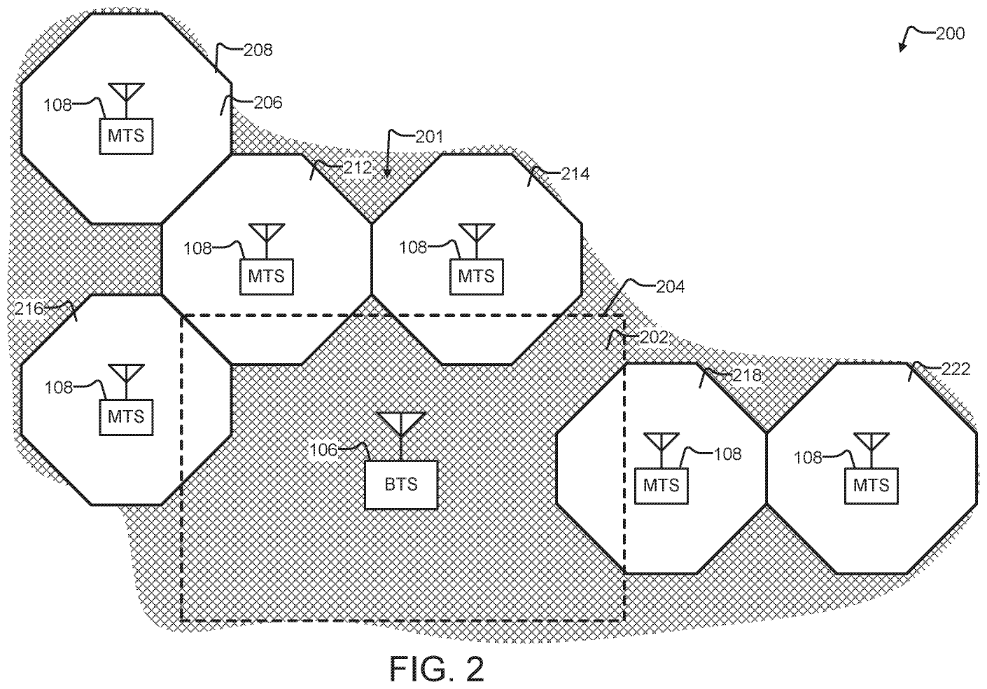

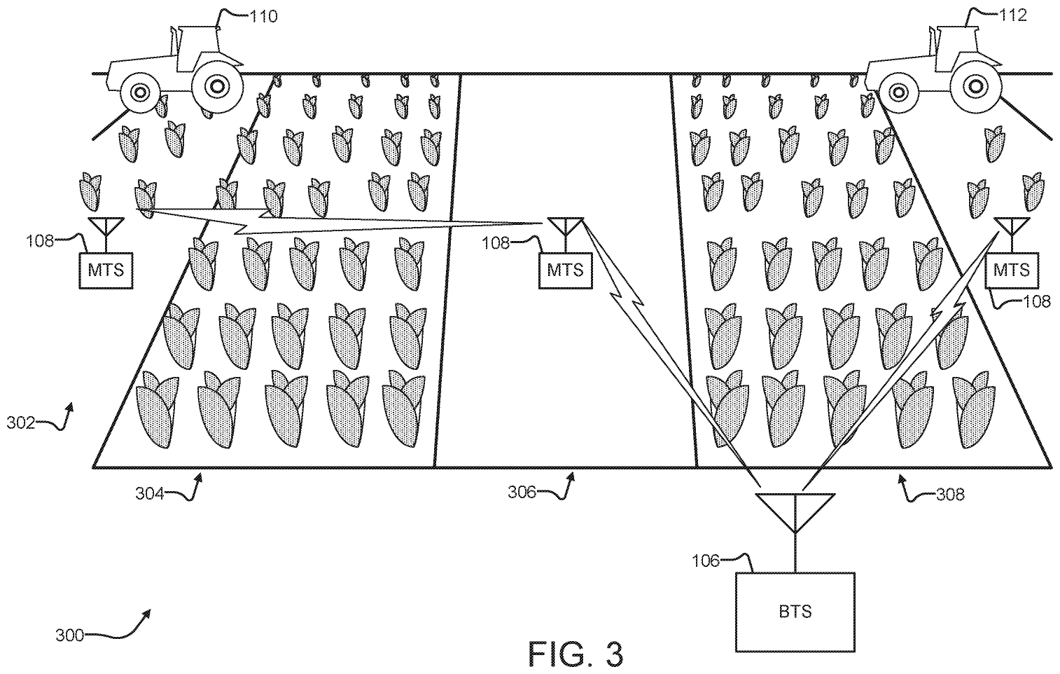

The areas served by remote nodes 108 of the network 100 may be arranged in a plurality of manners and combinations. Hereinafter, example combinations and implementations of the networking architecture illustrated in FIG. 1 are described in detail with reference to FIG. 2 and FIG. 3. It should be understood that variations from each of these particular examples is possible. The variations may be based on terrain, shape, and other attributes of an agricultural area. Furthermore, some of the networking connections may span areas not limited to agricultural use. For example, two or more remote nodes may have ranges that include areas that are not agricultural or specifically agricultural. Each of these combinations and variations is considered to be within the scope of this disclosure.

FIG. 2 is an example system 200 of real-time data replication and sharing in an agricultural area 201, using the agricultural communication network 100 of FIG. 1. As illustrated, the agricultural area 201 is an at least partial sum of individually served areas 202, 206, 212, 214, 216, 218, and 222. Each of the individually served areas 202, 206, 212, 214, 216, 218, and 222 is based on an operational range of an associated remote node 108 and the base station 106. It is noted that for the purpose of illustration, the range of each remote node 108 has been shown to be roughly of the same size and shape. However, in practicality, the ranges and shapes may vary or be substantially similar, depending upon terrain and obstructions. Furthermore, it should be understood that, for clarity of illustration, the area 201 has been shown to be greater than the individual areas served by the remote nodes 108.

When considered in combination, the access of any individual node 108 results in data access across all operational remote nodes 108 as described above. Data sharing may be based on neighboring remote nodes being within operating range with other remote nodes or overlapping ranges. For example, the minimum operating range of a remote node is shown by solid lines 208 and the minimum operating range of the base station 106 is shown by dashed line 204. Thus, a computing apparatus or working vehicle within boundary 208 may access data about any area served by an operational remote node 108 with an operational connection to the base station 106. Similarly, a computing apparatus or working vehicle within boundary 204 may access data about any area served by an operational node 108 through the base station 106. Furthermore, bi-directional communication of data from a computing apparatus or working vehicle to remote nodes 108 and/or base station 106 is also possible, such that other working vehicles and computing apparatuses within the area 201 may communicate with one another through the illustrated mesh network.

FIG. 3 is an additional example system 300 of real-time data replication and sharing in an agricultural area using the agricultural communication network 100 of FIG. 1. As illustrated, individual portions 302, 304, 306, and 308 of an agricultural area are served by remote nodes 108 and base station 106. Thus, working vehicle 110 and an associated computing apparatus may communicate with any remote node 108 within operating distance. Similarly, working vehicle 112 and an associated computing apparatus may communicate with any remote node 108 within operating distance. The working vehicles 110, 112 may receive working orders from associated remote nodes 108, transmit data to associated remote nodes 108 and receive data from associated remote nodes 108. Furthermore, working vehicles 110, 112 may collect agricultural data associated with a portion 302 or 308, respectively, of the agricultural area.

Accordingly, agricultural data collected by either of working vehicle 110 and 112 may be shared to a remote node 108. Thereafter, or at substantially the same time, the collected agricultural data originating from a particular remote node 108 may be replicated and shared by neighboring remote nodes 108 and the base station 106. In this manner, agricultural data related to any individual portion 302, 304, 306, and 308 of the agricultural area, and originating from a particular remote node 108, can be rapidly collected, shared, and accessed in substantially real-time, by a working vehicle or computer apparatus in range to a remote node 108 and/or base station 106.

Furthermore, data can be shared between working vehicles 110 and 112 using remote nodes 108, as described above. For example, working vehicle 110 may transmit data or communications to an associated remote node 108. The transmitted data may be replicated and/or shared by the remote nodes 108. Thereafter, the working vehicle 112 may receive the transmitted data or communications from an associated remote node 108. The transmitted data or communications can include agricultural data, status information, or other information related to the agricultural area or portions thereof being worked by agricultural vehicle 110 or 112. Additionally, working orders, coverage data, positioning data, weather data, germination data, feed data, irrigation data, and other associated data can be transmitted and accessed by working vehicles 110 or 112. Working orders can include basic information such as positioning or timing. Working orders can also a new or updated refueling threshold, product refill prediction, refliel prediction, unload prediction, guidance lines, task prioritization, or positioning data. These and other forms of data may be rapidly shared across the agricultural area 201.

As described above, working vehicles and computing devices in communication with at least one remote node 108 or base station 106 may rapidly share and access data related to an agricultural area 201 served by the communication systems disclosed herein. The data may be accessed in substantially real-time using the at least partial mesh configuration described above. Furthermore, bi-directional communication, including status information and communications, may be enabled between working vehicles and devices on the communication network. Additionally, replicated data can be processed by individual remote nodes 108 and the base station 106 to maintain an accurate status or overall working condition of the agricultural area 201.

Hereinafter, operational details related to individual components of the above systems are described with reference to several flowcharts and communication diagrams. It should be understood that these operational details may include steps to be performed in order, out of order, and sometimes in a substantially parallel manner. Furthermore, individual steps or operations can sometimes be omitted or altered, depending upon any desired implementation.

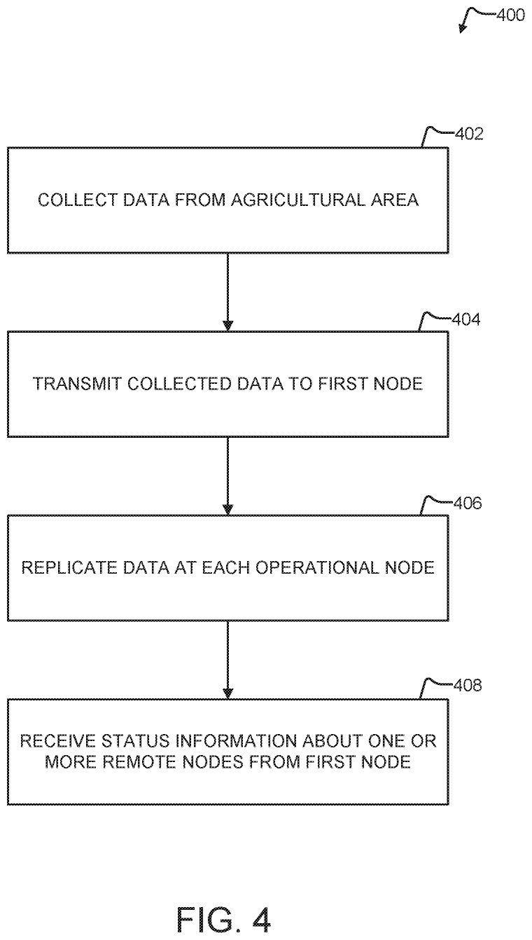

Turning now to FIG. 4, a flowchart of one embodiment of a method 400 of data sharing in an agricultural communication network, such as the agricultural communication network of FIG. 1, is illustrated. The method 400 can include collecting, from at least one agricultural machine (e.g., 110 or 112), data from the agricultural area, at block 402. The data may include any collectible data, such as soil data, water data, irrigation data, coverage data, and other suitable data. The data may be directly collected by the agricultural machine from the soil or environment, may be collected from sensors near, proximate, or embedded within the soil or environment, or may be recorded by an operator of the agricultural machine. Data may also be recorded using a video recording device or camera, audio device or microphone, or any other available device.

Thereafter, the method 400 includes transmitting, from the agricultural machine, the collected data to a first remote node of the plurality of remote nodes 108, at block 404. The agricultural machine may be in communication with a first remote node within an operating range of the first remote node. The agricultural machine may use an onboard computing apparatus or radio to transmit the collected data to the remote node.

Upon receipt of the data at the first remote node, the agricultural communication network may operate to rapidly share and replicate the data such that status information related to the agricultural area is updated on the fly and available in a real-time manner. In this regard, the method 400 can also include replicating the collected data at each operational remote node of the plurality of remote nodes neighboring the first remote node, at block 406. The data replication may be facilitated through on-board data storage at each remote node as well as at the base station 106.

Thus, upon replication, any agricultural vehicle or computing device on the communication network may receive data related to a working condition, partial working condition, or overall working condition of the agricultural area in a real-time manner. For example, the method 400 can include receiving, at an agricultural machine, status information originating from one or more remote nodes of the plurality of remote nodes from the first remote node, at block 408. This status information may have been collected from other agricultural machines working other areas, may have been input at computing devices on the network, or may have been collected from sensors and/or autonomous vehicles.

As described above, the method 400 can include data replication across multiple remote nodes. It is noted that such data replication may facilitate data aggregation at the base station 106 or any remote node. As such, the method 400 can also include receiving agricultural data from the plurality of remote nodes and assembling the agricultural data into an overall working condition indicative of a state of the agricultural area associated with the partial mesh configuration. The base station 106 and/or remote nodes 108 can also transmit the overall working condition to agricultural machines or computing devices on the communication network.

Generally, as used herein, the overall working condition can include the state of the agricultural area as described above and adaptive working conditions, as well. For example, field conditions vary, as do optimal timing for operations, as these conditions are all dynamic in nature. However, the network 100 may provide for growers to make decisions for optimizing operations (e.g., increase yield, harvest quality, reduce fuel consumption, etc.) as predictive operations that are adaptable to the working conditions, as opposed to reactive operations. The system and network 100 allow for any level of automation required, as set forth in a number of examples presented below.

Considering an example scenario of baling hay, there is an optimal time to bale hay (e.g., based on moisture content of hay) through various methods of determining moisture content with sensors, drone scouting, or even weather station data. Using the real-time nature of the data transmitted and shared through the network 100, the moisture data can be used to determine the optimal time to actually bale; i.e., the system could actually setup a work order to bale hay at a certain specific time based upon that data. A similar work order could also be applied for the cutting of hay based on optimal crop growth stage, optimal weather, and other considerations. Similarly, tillage work may be ordered when ground conditions are actually optimal based on sharing of data across the network 100. Thus, the network 100 allows for adaptive working conditions in the scenario.

Other example scenarios can include spraying at optimal times as to utilize the best timing for optimal or 100% chemical absorption into the plants/ weeds. Conversely, prevention of spraying based on wind conditions which are being streamed to the Mesh network 100 via a weather station. Other scenarios can include optimized harvesting based on real-time conditions including heat, humidity, geographic area, vehicle locations, and/or vehicle availability.

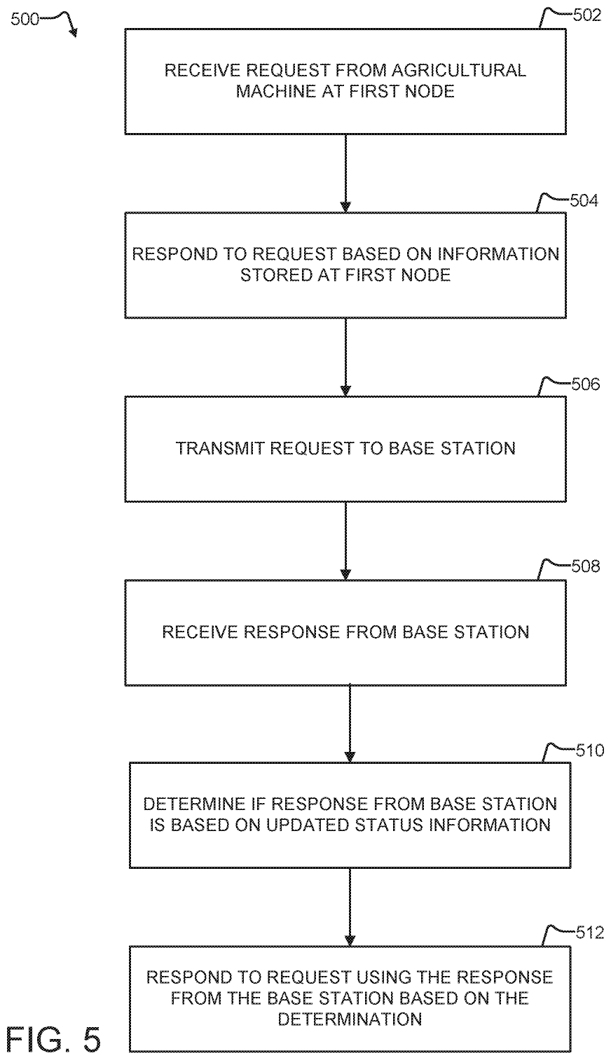

Other data sharing operations, such as fulfilling requests for information, statuses, and data related to the agricultural area, can also be facilitated through the examples described herein. FIG. 5 illustrates a flowchart of one embodiment of a method 500 of data sharing in an agricultural communication network, such as the agricultural communication network of FIG. 1. The method 500 can include receiving, at the first remote node, a request from an agricultural machine, at block 502. The request may be any suitable request related to the agricultural area. For example, the request may include a request for working orders, guidance, telematics, yields, or prescriptions. The request may also include a request for refueling, unloading, or other working conditions.

Thereafter, the method 500 includes responding, by the first remote node, to the request based on information stored or shared by the first remote node, at block 504. As described above, data is replicated relatively rapidly across the communication network. Thus, the first remote node may comprise or store all necessary information to facilitate the request.

Additionally, the first remote node may also transmit the request to the base station, at block 506. This transmission may serve to ensure updated information is used to respond to the request. Thereafter, the method 500 can include receiving, at the first remote node, a response from the base station, at block 508. The base station response may include information from the remote server 104, for example, or other supplemental information.

Upon receipt of the base station response, the method 500 can include determining, at the first remote node, if the response from the base station is based on updated status information about the agricultural area, at block 510. If the response includes updated status information, the first remote node can further respond to the working vehicle request using the response from the base station, at block 512.

As described above, the communication network 100 and its various implementations facilitate rapid sharing and data replication, as well as fulfilling requests for information from various devices on the network. Additional operational details can include communication of working orders and automation capabilities, as described below.

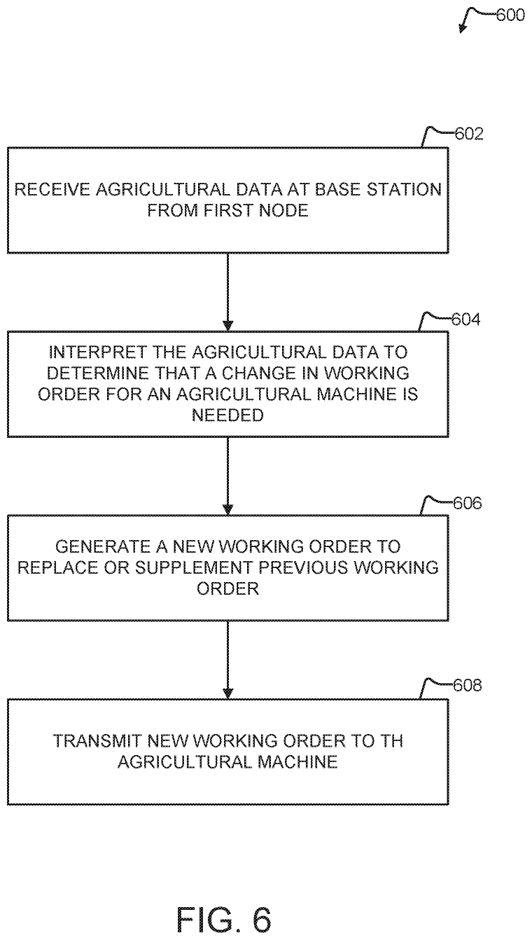

FIG. 6 illustrates a flowchart of one embodiment of a method 600 of communication in an agricultural communication network, such as the agricultural communication network of FIG. 1. The method 600 can include receiving, at the base station, agricultural data from a first remote node, at block 602. The agricultural data can include data related to the agricultural area, including coverage data, positioning data, weather data, germination data, feed data, irrigation data, or other suitable data.

Upon receipt, the method 600 can include interpreting, at the base station, the agricultural data to determine that a change in at least one working order for an agricultural machine is needed, at block 604. For example, the received data may indicate that the agricultural machine is needed in a different area or portion of the agricultural area. The received data may also indicate other necessary changes, such as changes based on equipment available to the agricultural machine.

The method 600 can further include generating, at the base station, at least one new working order for the agricultural machine based on the determination, at block 606. The new working order may be based on the necessary change, and can include supplemental working orders, replacement working orders, or the like. The working orders may include positioning information or guidance information for autonomous control, as well.

Thereafter, the method 600 can include transmitting the at least one new working order to the agricultural machine through the first remote node, at block 608. As described above, the working order can be relayed across the bridged connection of the at least partial mesh network, or in some instances may be directly transmitted to the first remote node or the agricultural machine, if in range of the base station.

The operational characteristics described above provide for data replication and sharing related to data collected from an agricultural area. However, it is noted that the same may include communications data, as well.

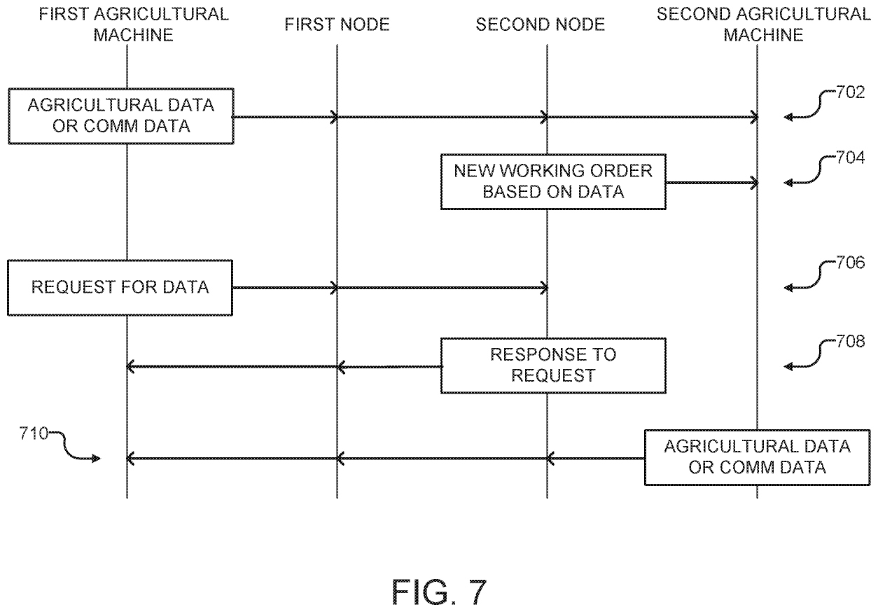

FIG. 7 illustrates a communication diagram of one embodiment of a method 700 for vehicle-to-vehicle communications in an agricultural communication network, such as the agricultural network of FIG. 1. The diagram of FIG. 7 represents at least two remote nodes and at least two agricultural vehicles. It should be understood that any number of intervening remote nodes may be applicable. Accordingly, the communication scheme illustrated should not be limited to two remote nodes.

As illustrated, the first agricultural machine may transmit agricultural data and communications data across remote nodes of the network, to a second agricultural machine, at 702. The communication can be bi-directional, as shown at 710.

Additionally, individual remote nodes, such as the second node, can make determinations about working order changes based on the communication data, as shown at 704. Similarly, individual remote nodes, such as the second remote node, can respond to requests for data, including communication data, as shown at 706, 708.

These communication capabilities may facilitate vehicle-to vehicle communications in a substantially real-time manner. For example, the first agricultural machine may directly communicate with the second agricultural machine using the network of remote nodes to relay data. The use of this communication paradigm may be useful in a variety of scenarios. For example, if there is no direct line of sight between two working vehicles, or if weather conditions are causing bad reception for typical radio communications, the mesh network 100 may allow fast data sharing despite these conditions. Furthermore, due to the relatively fast nature of connecting to a particular remote node over a wireless communication protocol, and the immediate availability of all data stored thereon, remote vehicles coming into range of at least one remote node may have access to these communication features to immediately communication with other vehicles connected to the mesh network.

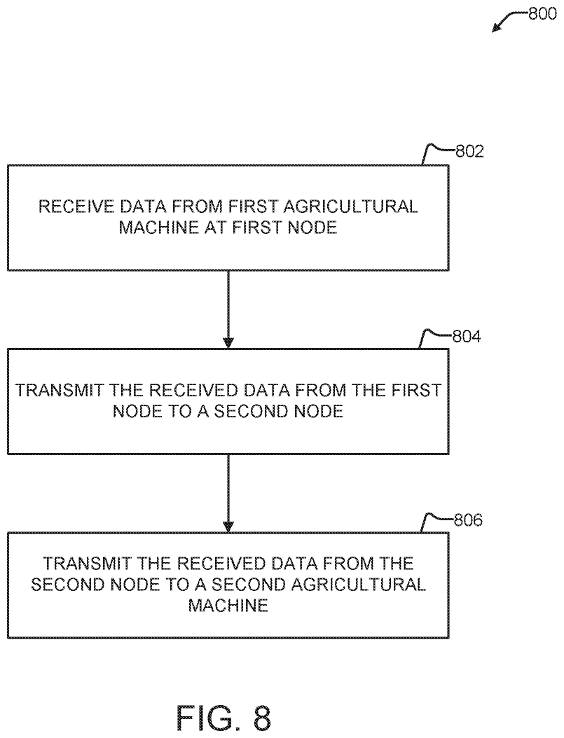

FIG. 8 illustrates a flowchart of one embodiment of a method 800 for vehicle-to-vehicle communications in an agricultural communication network, such as the agricultural communication network of FIG. 1. The method 800 is based on the communication diagram of FIG. 7 above, and illustrates one particular example. The method 800 can include receiving data from a first agricultural machine at a first remote node of an agricultural mesh network, at block 802. Generally, the first remote node must be in operative range to the first agricultural machine and a second remote node.

Thereafter, the method 800 can include transmitting the data from the first remote node to the second remote node, at block 804. The transmitting can include transmission across any number of intervening nodes, as described above.

Finally, the method 800 can include transmitting the data from the second remote node to the second agricultural machine. Generally, a useful scenario includes one where the second agricultural machine is out-of-operative-range from the first remote node and in operative range to the second remote node. In this scenario, direct vehicle radio communications may not be an option, and therefore utilizing the rapid data sharing capabilities of the network 100 facilitates these communications as though they were direct.

As described above, a plurality of systems and methods for data replication, sharing, and communication have been described. The systems and methods may be facilitated through one or more remote nodes and a base station or central node. Each remote node may include a transceiver and/or computer apparatus. The computer apparatus may be a general or specialized computer apparatus configured to perform various functions related to data transmission, data receipt, data storage, data replication, and other functions.

For example, FIG. 9 depicts a block diagram of an example computing system 900 that can be used to implement one or more components of the systems according to example embodiments of the present disclosure. For example, the computing system 900 may implement a mobile transceiver station or remote node, a base transceiver station or base station, and/or a data center in communication with the same. As a further example, the computing system 900 may also be used to implement computing apparatuses in agricultural vehicles, remote computing apparatuses, such as tablets or mobile phones, computer terminals, and other suitable devices.

As shown, the computing system 900 can include one or more computing device(s) 902. The one or more computing device(s) 902 can include one or more processor(s) 904 and one or more memory device(s) 906. The one or more processor(s) 904 can include any suitable processing device, such as a microprocessor, microcontroller, integrated circuit, logic device, or other suitable processing device. The one or more memory device(s) 906 can include one or more computer-readable media, including, but not limited to, non-transitory computer-readable media, RAM, ROM, hard drives, flash drives, or other memory devices.

The one or more memory device(s) 906 can store information accessible by the one or more processor(s) 904, including computer-readable instructions 908 that can be executed by the one or more processor(s) 904. The instructions 908 can be any set of instructions that when executed by the one or more processor(s) 904, cause the one or more processor(s) 904 to perform operations. The instructions 908 can be software written in any suitable programming language or can be implemented in hardware. In some embodiments, the instructions 908 can be executed by the one or more processor(s) 904 to cause the one or more processor(s) 904 to perform operations, such as the operations for communication, data replication, and data sharing, as described with reference to FIGS. 4-8.

The memory device(s) 906 can further store data 910 that can be accessed by the processors 904. For example, the data 910 can include coverage data, positioning data, weather data, germination data, feed data, irrigation data, and other suitable data, as described herein. The data 910 can include one or more table(s), function(s), algorithm(s), model(s), equation(s), etc. for collecting and processing data, and for generating working orders based on collected data, according to example embodiments of the present disclosure.

The one or more computing device(s) 902 can also include a communication interface 912 used to communicate, for example, with the other components of the system and/or other computing devices. The communication interface 912 can include any suitable components for interfacing with one or more network(s), including for example, transceivers, transmitters, receivers, ports, controllers, antennas, or other suitable components.

The computing system 900 can also include a power source 920 used to power the one or more computing devices 902, and a backup power source 922 used to power the one or more computing devices 902 under particular power loss or reduced power conditions. For example, the power source 920 may be solar power based on solar cells or other solar power devices, and the backup power source 922 can include a backup battery or backup batteries.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

It is to be understood that the steps of the methods 400, 500, 600, 700, and 800 are performed by the controller 904 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 904 described herein, such as the methods 400, 500, 600, 700, and 800, is implemented in software code or instructions which are tangibly stored on a tangible computer readable medium. The controller 904 loads the software code or instructions via a direct interface with the computer readable medium or via a wired and/or wireless network. Upon loading and executing such software code or instructions by the controller 904, the controller 904 may perform any of the functionality of the controller 904 described herein, including any steps of the methods 400, 500, 600, 700, and 800 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system of real-time data replication and sharing in an agricultural area, the system comprising:
a base station, the base station comprising at least one transceiver being operative to receive and transmit data collected from the agricultural area;
a plurality of remote nodes in operative communication with the base station, each of the plurality of remote nodes being positioned within a predetermined range from the base station or a predetermined range from each other in at least a partial mesh configuration and comprising at least one transceiver being operative to receive and transmit data from the base station and receive, replicate, and transmit data collected from neighboring remote nodes of the plurality of remote nodes and the agricultural area; and
at least one agricultural machine within range of the base station or at least one of the remote nodes, the at least one agricultural machine comprising a computer apparatus configured to receive data from the agricultural area, to transmit the received data to a first remote node of the plurality of remote nodes, and to receive replicated data originating from one or more remote nodes of the plurality of remote nodes from the first remote node.

2. The system of claim 1, wherein the base station is further configured to transmit data related to the agricultural area to a server in communication with the Internet.

3. The system of claim 1, wherein the data collected from the agricultural area comprises at least one of coverage data, positioning data, weather data, germination data, feed data, or irrigation data.

4. The system of claim 1, wherein each node of the plurality of nodes is configured to store data associated with one or more neighboring remote nodes of the plurality of remote nodes.

5. The system of claim 1, wherein each node of the plurality of nodes is configured to at least partially bridge communications from a neighboring node to the base station.

6. The system of claim 1, wherein the base station and remote nodes are configured to transmit and receive data over a wireless communication protocol.

7. The system of claim 1, wherein the base station is configured to generate at least one new working order for the at least one agricultural machine, the at least one new working order comprising at least one of a new or updated refueling threshold, product refill prediction, refuel prediction, unload prediction, guidance lines, task prioritization, or positioning data.

8. The system of claim 1, wherein the base station is configured to generate at least one new working order for the at least one agricultural machine, the at least one new working order comprising relocation to a different portion of the agricultural area.

9. The system of claim 1, wherein each remote node of the plurality of remote nodes is a solar powered-device with backup battery power, and wherein each remote node is configured to provide a power status to the base station.

10. The system of claim 1, wherein the computer apparatus of the at least one agricultural machine is further configured to provide a graphical user interface to an operator of the at least one agricultural machine, the graphical user interface comprising, at least, the data related to the one or more remote nodes.

11. The system of claim 1, wherein the data related to the one or more remote nodes comprises an overall working condition collected and assembled from each operational remote node of the plurality of remote nodes.

12. The system of claim 1, wherein each remote node of the plurality of remote nodes is configured to replicate communication with the base station to the at least one agricultural machine.

13. The system of claim 1, wherein the at least one agricultural machine is a first agricultural machine, the system further comprising a second agricultural machine, and wherein the plurality of remote nodes are configured to relay data received from the first agricultural machine to the second agricultural machine.

14. A method of data replication and transmission in an agricultural area with a communications system, the communications system comprising a base station, a plurality of remote nodes in operative communication with the base station, and at least one agricultural machine within range of the base station or at least one of the remote nodes, the method comprising:
collecting, at the at least one agricultural machine, data from the agricultural area;
transmitting, from the at least one agricultural machine, the collected data to a first remote node of the plurality of remote nodes;
replicating the collected data at each operational remote node of the plurality of remote nodes neighboring the first remote node; and
receiving, at the at least one agricultural machine, status information originating from one or more remote nodes of the plurality of remote nodes from the first remote node.

15. The method of claim 14, further comprising:
receiving, at the first remote node, a request from the at least one agricultural machine;
responding, by the first remote node, to the request based on information stored or shared by the first remote node;
transmitting, by the first remote node, the request to the base station;
receiving, at the first remote node, a response from the base station;
determining, at the first remote node, if the response from the base station is based on updated status information about the agricultural area; and
responding to the request using the response from the base station based on the determination.

16. The method of claim 14, further comprising:
receiving, at the base station, agricultural data from the first remote node;
interpreting, at the base station, the agricultural data to determine that a change in at least one working order for the at least one agricultural machine is needed;
generating, at the base station, at least one new working order for the at least one agricultural machine based on the determination; and
transmitting the at least one new working order to the at least one agricultural machine through the first remote node.

17. The method of claim 14, further comprising:
receiving a request from the at least one agricultural machine;
responding to the request based on information stored or shared by the first remote node; and
transmitting the request to the base station.

18. The method of claim 17, further comprising:
receiving a response from the base station;
determining if the response from the base station is based on updated status information about the agricultural area; and
responding to the request using the response from the base station based on the determination.

19. The method of claim 14, further comprising:
receiving agricultural data from the plurality of remote nodes;
assembling the agricultural data into an overall working condition indicative of a state of the agricultural area associated with the partial mesh configuration; and
transmit the overall working condition to the at least one agricultural machine.

20. The method of claim 14, further comprising:
receiving agricultural data from the first remote node;
interpreting the agricultural data to determine that a change in at least one working order for the at least one agricultural machine is needed;
generating at least one new working order for the at least one agricultural machine based on the determination; and
transmitting the at least one new working order to the at least one agricultural machine through the first remote node.
